(19) United States
(12) Patent Application Publication
(10) Pub. No.: US 2008/0127907 A1
(43) Pub. Date: Jun. 5, 2008

(54) Animal cast protection system

(76) Inventors: James Purtell, Huntington Woods, MI (US); Broc Johnson, Walloon Lake, MI (US)

Correspondence Address: HARNESS, DICKEY & PIERCE, P.L.C., P.O. BOX 828, BLOOMFIELD HILLS, MI, 48303, US

(21) Appl. No.: 11/825,840

(22) Filed: Jul. 9, 2007

Related U.S. Application Data
(60) Provisional application No. 60/872,807, filed on Dec. 4, 2006.

(51) Int. Cl. A61D 9/00

(52) U.S. Cl. 119/850

(57) ABSTRACT

A protection system for a medical appliance on a limb of an animal includes a tubular portion that is open at a first end and sealed at a second end. The first end is adapted to receive the limb, which extends from the first end to the second end. A belt loop strap is coupled to and extends at least partially along a length of the tubular portion. The belt loop strap includes at least one opening. At least one strap fits through the opening and secures the tubular portion to the limb.

### CROSS-REFERENCE TO RELATED APPLICATIONS

This application claims the benefit of U.S. Provisional Application No. 60/872,807, filed on Dec. 4, 2006. The disclosure of the above application is incorporated herein by reference in its entirety.

### FIELD

The present disclosure relates to medical care for animals, and, more particularly to a medical appliance protection system for an animal.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

It is often the case that an animal, such as a dog, may be injured such that it will require attachment of a medical appliance, such as stitches or bandaging, to one of its appendages for recovery. The bandaging or stitching may become wet or dirty when the animal is outside.

Current systems for protecting medical appliances for dogs include wrapping the appliance and appendage in plastic and securing it with tape or elastic. Dog owners are often advised to re-wrap the medical appliance and appendage every time the dog needs to go outside. As the healing process may require several weeks or months, maintaining a clean dry dressing or medical appliance for an injury becomes increasingly difficult.

### SUMMARY

A protection system for a medical appliance on a limb of an animal includes a tubular portion that is open at a first end and sealed at a second end. The first end is adapted to receive the limb, which extends from the first end to the second end. A belt loop strap is coupled to and extends at least partially along a length of the tubular portion. The belt loop strap includes at least one opening. At least one strap fits through the opening and secures the tubular portion to the limb.

According to other features of the disclosure, at least one of a D-ring, an O-ring, Velcro, a barrel lock, and a buckle are adapted to secure the at least one strap. The first end includes a contoured edge. The second end includes an area for traction. The area includes a screened print that could provide traction. The at least one strap includes an elastic material. The belt loop strap includes a plurality of openings. The at least one strap laces through the plurality of openings. The tubular portion includes a semi-transparent poly-vinyl material.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1-16 are protection systems for medical appliances according to aspects of the present disclosure; and

FIGS. 17-19 are protection systems for medical appliances in operation.

### DETAILED DESCRIPTION

The following description is merely exemplary in nature and is in no way intended to limit the disclosure, its application, or uses. For purposes of clarity, the same reference numbers will be used in the drawings to identify similar elements. For a more complete understanding of the disclosure, reference now should be made to the embodiments illustrated in greater detail in the accompanying figures and described below by way of examples of the disclosure. In the following description, various operating parameters and components have been described for a number of embodiments. The specific parameters and components are included as examples and are not meant to be limiting. As used herein, the phrase at least one of A, B, and C should be construed to mean a logical (A or B or C), using a non-exclusive logical or.

While the present disclosure described primarily with respect to a protective sock or protective system for covering a medical appliance, such as a cast, splint, bandage, or wrapping, secured to one or more appendages, such as a fore limb or hind limb, of an animal, the present disclosure may be adapted to various applications requiring protective coverings, as will be understood by one skilled in the art.

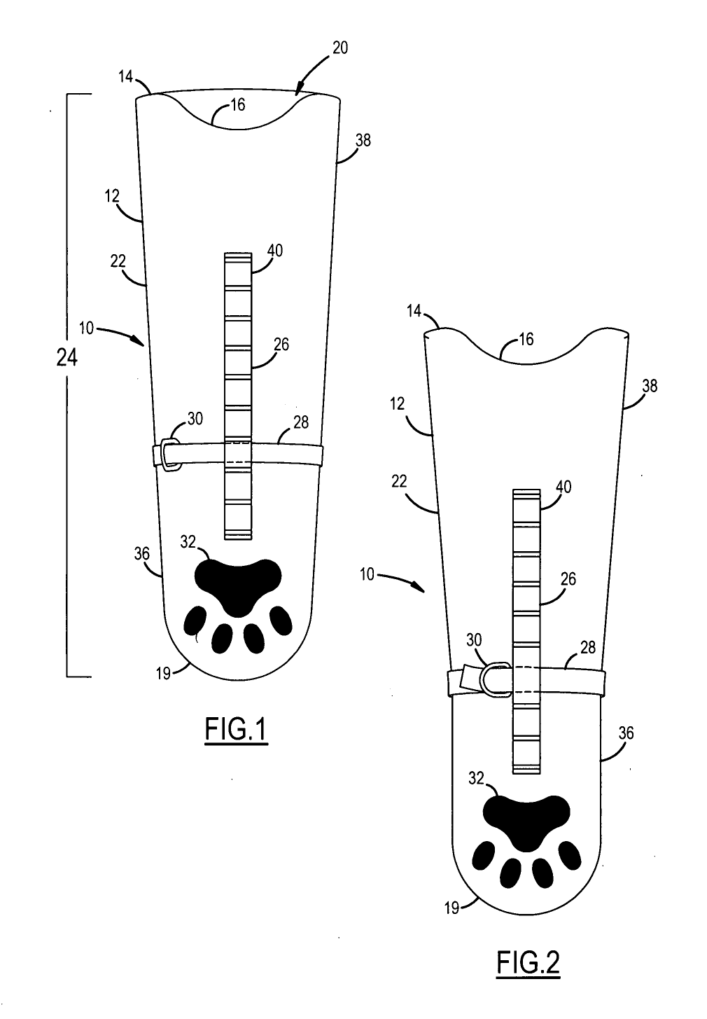

Referring to FIG. 1, the protection system 10 or bandage and cast protection for animals, alternatively referred to as a Pee-Paws™ system, is illustrated in accordance with one embodiment of the present disclosure. The protection system 10 includes a tubular shaped portion 12 having an upper portion 14 defining an opening having a contoured edged 16. The tubular shaped portion 12 also includes a lower sealed portion 17 and an interior cavity 20, defined between the upper and lower portions, for receiving and containing an animal appendage. The upper portion may be cut for reducing size of the system 10 for smaller animals.

The interior cavity 20 has a corresponding exterior 22 having an exterior length 24, such that an integral belt loop strap 26 extends along a portion of the exterior length 24. Coupled through the belt loop strap 26 is a strap 28 for securing and tightening the tubular shaped portion 12 to an animal appendage. The strap 28 is adjusted or tightened through a securing device 30, such as a D-ring or an O-ring configuration. A screened print or other integral traction device 32 is in an area of the lower portion 17 such that an animal using the protection system 10 will have traction through the device 10 when walking on the ground.

Important to note is that the present embodiment includes a semi-transparent poly-vinyl sock-like device ranging in thickness from 0.05 mills to 0.10 mills, however, various other materials and thicknesses may be used providing the system 10 is flexible.

Referring to FIGS. 1-6, various embodiments of the present disclosure are illustrated. Each of these embodiments include the integral belt loop strap 26 extending along the exterior length 24 above a paw portion 36 in an area of the lower sealed portion 17 and extending below an upper leg portion 38. The integral belt loop strap 26 includes a plurality of discrete belt loops 40 such that the strap 28 may be coupled to the tubular shaped portion 12 at varying heights, thereby tailoring the tightening scheme of the present disclosure into the features and characteristics of the animal appendage on which the protective sock or protection system 10 is dressed.

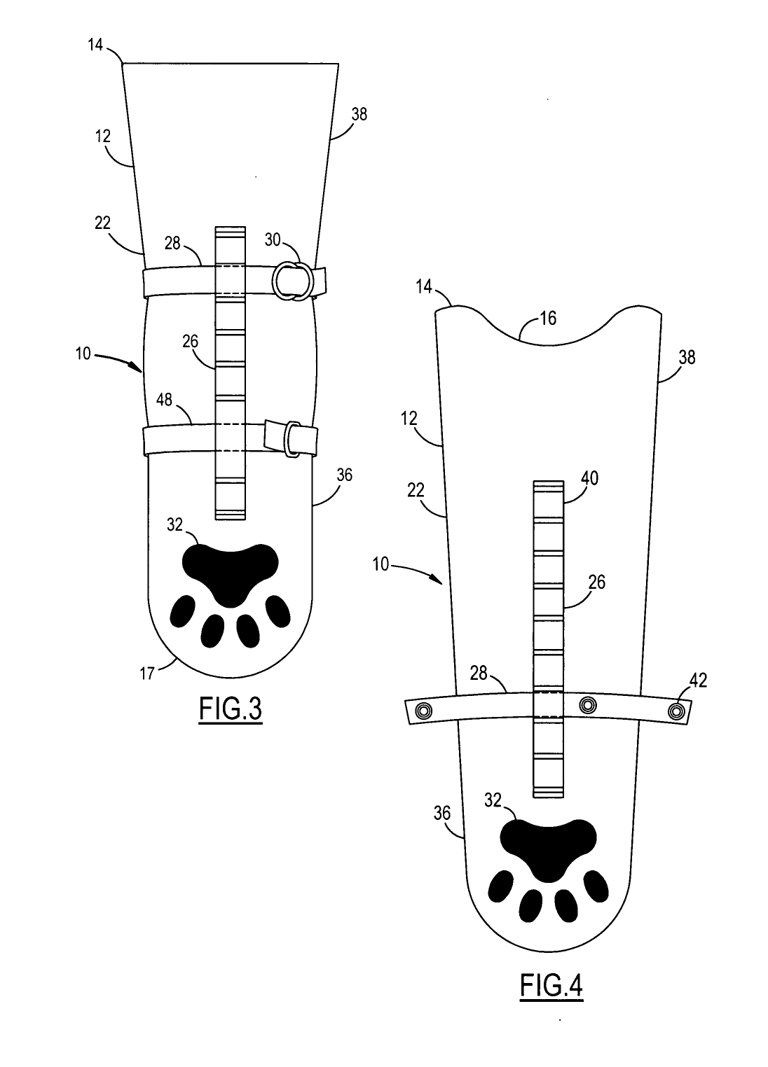

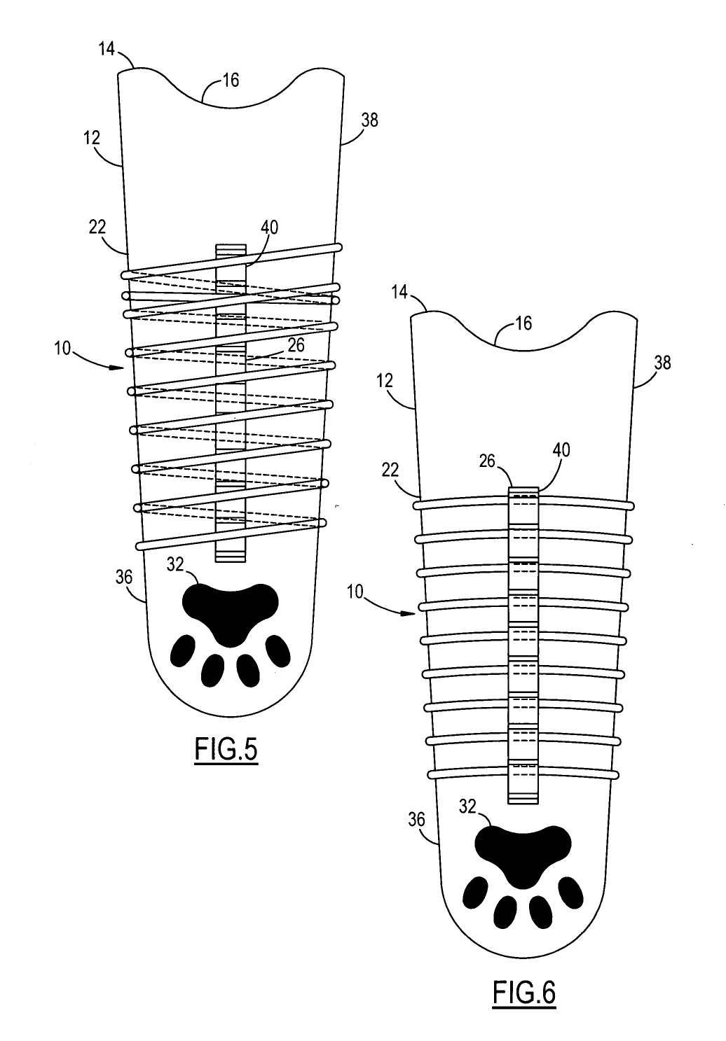

The strap 28 may include various configurations, such that, as shown in FIG. 1, the strap 28 is a single elastic band having a securing device 30 illustrated as a D-ring. The securing device 30, as illustrated in FIG. 2, may also include an O-ring configuration. Further, the strap 28 may include snapping closures 42 for adjustably snapping together the elastic strap 28 in one of the plurality of discrete belt loops 40, as illustrated in FIG. 4. Still further, an alternative strap design, such as elastic cords 44 or bungee cords may be coupled to one or more of the plurality of belt loops 40 such that the elastic cord 44 is laced, as in FIG. 5. Similarly, a plurality of elastic cords 46 may be looped through the plurality of belt loops 40, as in FIG. 6. Alternatively, as in FIG. 3, a first elastic band 28 and a second elastic band 48 may be coupled to the system 10 at different members of the plurality of belt loops 40. The use of two elastic bands minimizes the amount of elastic straps required while still tailoring the protection system 10 to the various curvatures or joints of the animal appendage.

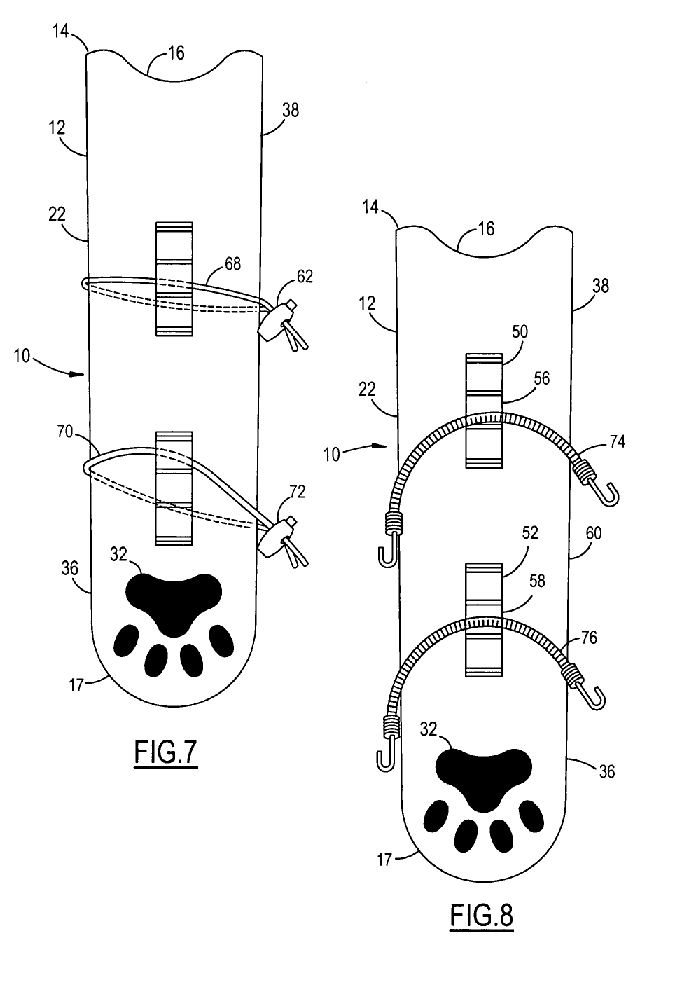

Referring to FIGS. 7-10, alternate embodiments of the present disclosure are illustrated. As with the integral belt loop strap discussed above, FIGS. 7-10 illustrate a first belt loop strap 50 and a second belt loop strap 52 each having a plurality of belt loops 56, 58. The first belt loop strap 50 is positioned along the exterior length adjacent to the upper leg portion 38, whereas the second belt loop strap 52 is positioned along the exterior length adjacent to the paw portion 36. Between the first belt loop strap 50 and the second belt loop strap 52 is an area 60 where typically a joint of the animal will be positioned such that tightening along a belt strap will not be necessary.

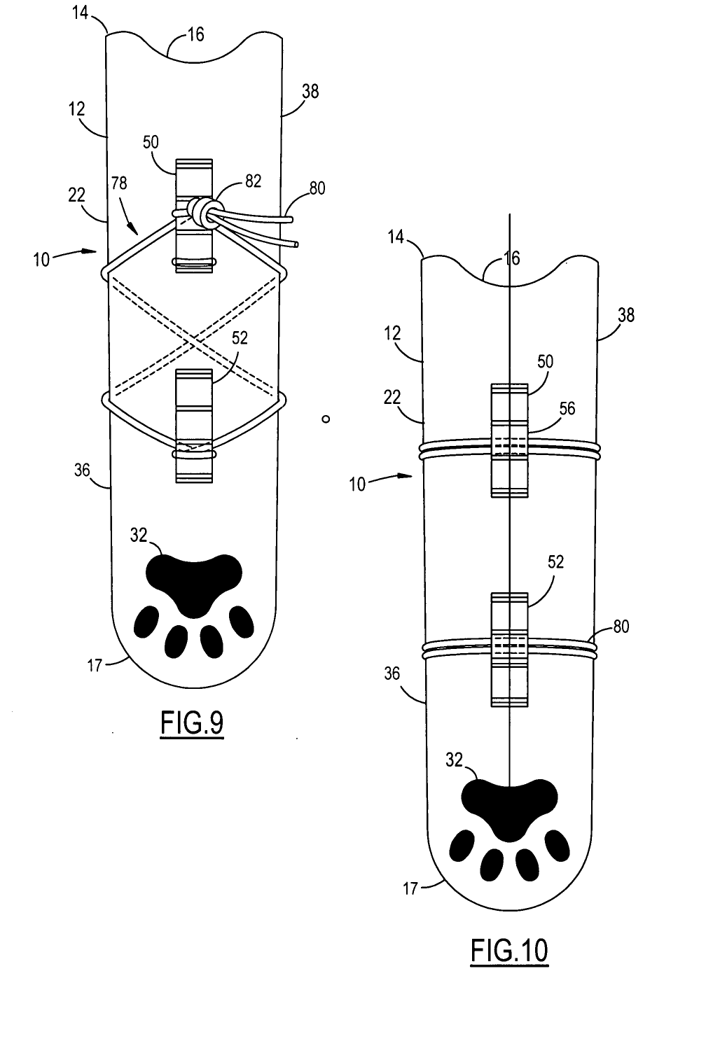

Further designs of the strap configuration are illustrated such that, in FIG. 7, elastic cords having barrel lock closures adjusting the cords 68 are illustrated whereby the first cord 68 is adjusted through the first belt loop section 50 through a first barrel lock closure 62; and a second cord 70 is adjusted through the second belt loop strap 52 through a second barrel lock closure 72. In FIG. 8, instead of the elastic cords and barrel locks of FIG. 7, bungee cords 74 and 76 are included for tightening the protection system 10. In FIG. 9, a lace configuration 78 is arranged through lacing of an elongated elastic cord 80 through both of the belt loop straps 50, 52 in a bi-lateral lace design. The lace configuration 78 is secured through a barrel lock 82 or other securing device. In FIG. 10, non-elastic or elastic Velcro strips 78, 80 are used to tighten the protection system 10 in an area of the belt loop straps 50, 52.

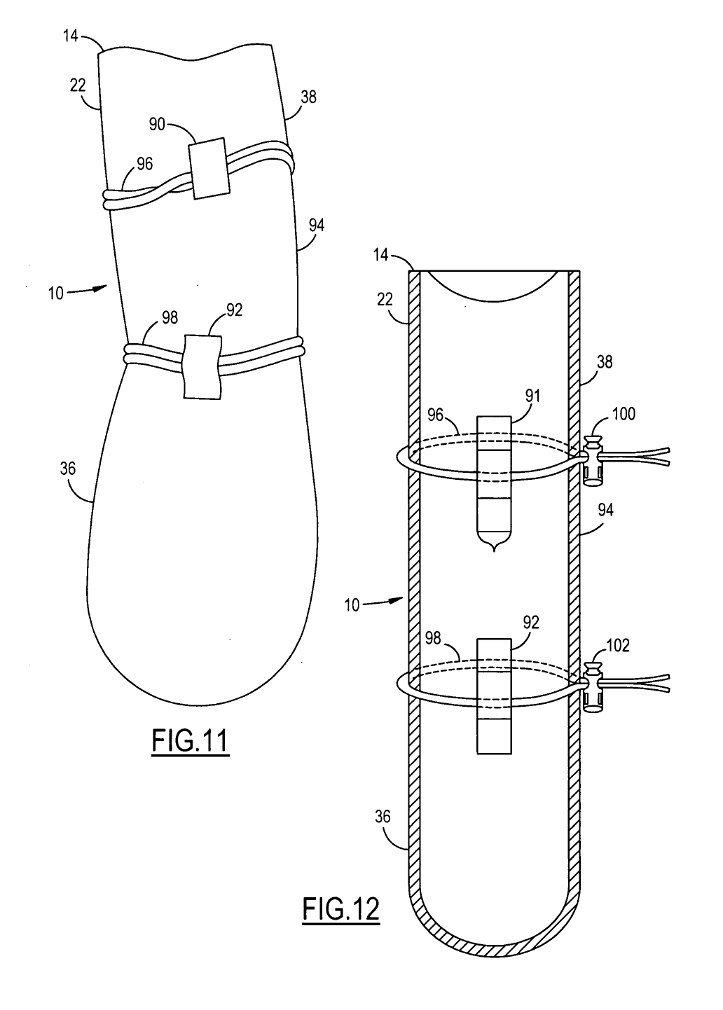

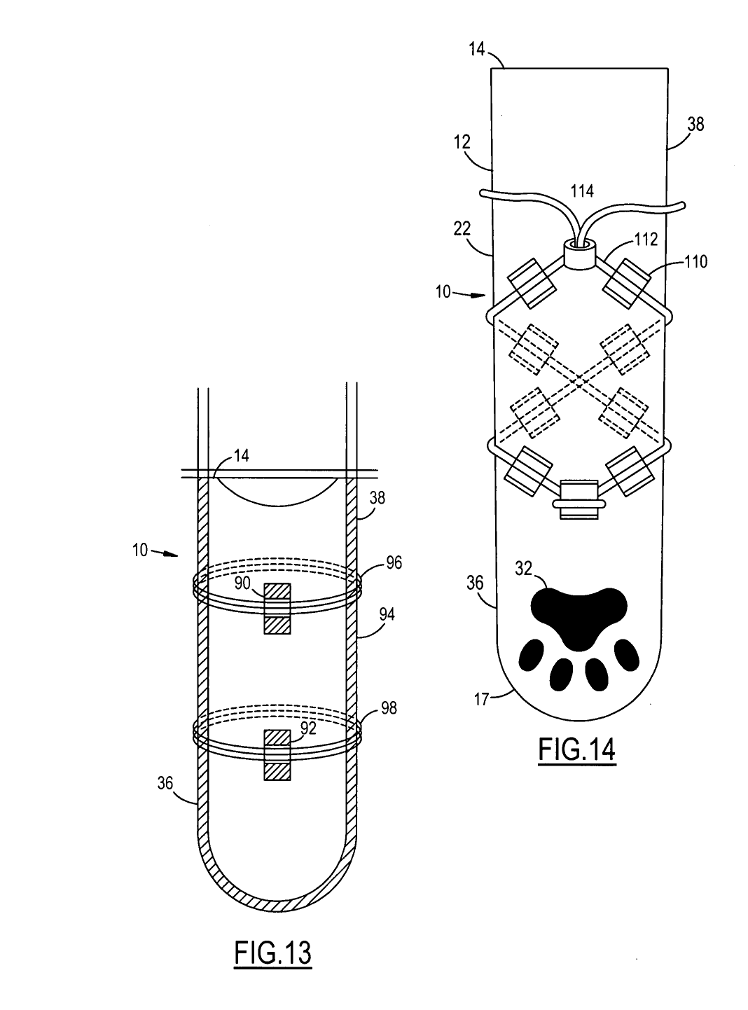

Referring to FIGS. 11-13, alternate embodiments of the present disclosure are illustrated. In accordance with these embodiments, a first belt loop 90 is coupled to the exterior 22 adjacent the upper portion 38, and a second belt loop 92 is coupled to the exterior 22 above the lower portion 36. The first belt loop 90 and the second belt loop 92 are positioned a distance 94 from each other, such that the distance 94 is sized for accommodating a joint of an animal or a contour of an animal appendage. A first strap 96 may be coupled through the first belt loop 90, and a second strap 98 may be coupled through the second belt loop 92 to secure the joint or appendage contour therebetween. The straps 96, 98 are secured by either plain elastic bands, as in FIGS. 11 and 13, or through barrel locks 100, 102, as in FIG. 12.

Referring to FIG. 14, an alternative embodiment of the present disclosure is illustrated including a plurality of belt loops 110 positioned at angles relative to each other such that a cross lattice belt configuration 112 may be fed therethrough and secured at a barrel lock 114.

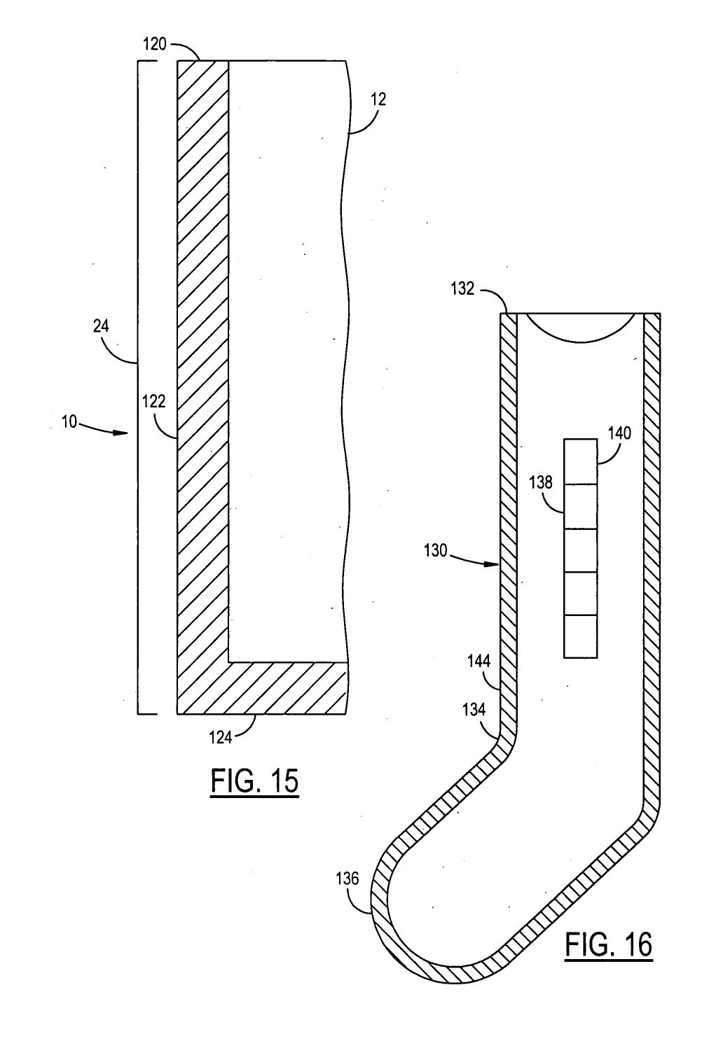

Referring to FIG. 15, an alternative embodiment of the present disclosure is illustrated such that a tightening portion extends substantially the entire exterior length 24 and along a side 120 of the tubular shaped portion 12. This tightening portion 122 may also be a strengthening portion as needed in high-wear areas of the tubular shaped portion 12. In accordance with this embodiment, a strengthening portion 124 may also be coupled to the lower portion 17, as the lower portion 17 may be a high use area.

Referring to FIG. 16, an alternate embodiment of the present disclosure is illustrated in accordance with another embodiment of the present disclosure. This embodiment 130 includes an upper portion 132, a hinge portion 134, and a lower portion 136. The upper portion 132 is designed to receive a hind animal appendage such that the natural bend of the appendage is accommodated by the hinge portion 134 and is held in place through the closed lower portion 136. The tubular shaped portion embodied 130 herein also includes a belt loop strap 138 including a plurality of belt loops 140 and extending from an area 142 below the upper portion 132 and to an area 144 above the hinge portion 134.

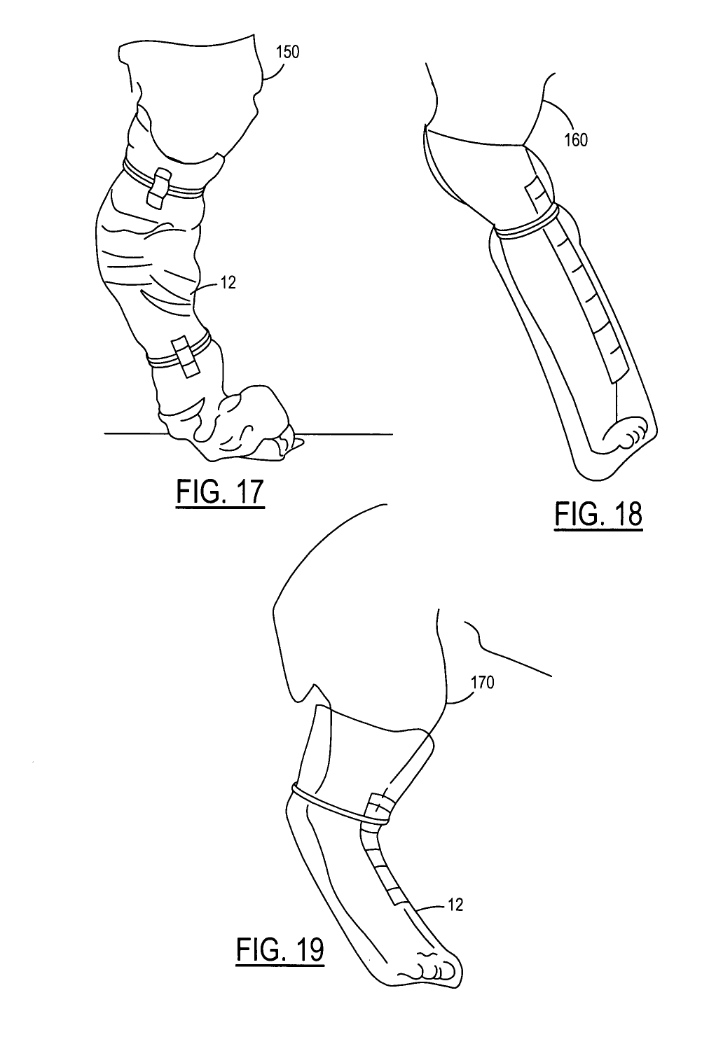

Referring to FIG. 17, an example of the tubular shaped portion 12 on an animal appendage 150 is illustrated in accordance with another embodiment of the present disclosure. Referring to FIG. 18, an alternate embodiment of the present disclosure is illustrated on an animal appendage 160 in accordance with another embodiment of the present disclosure. Referring to FIG. 19, an alternate embodiment of the tubular shaped portion 12 is illustrated coupled to an animal appendage 170 in accordance with another embodiment of the present disclosure.

While the disclosure has been described in connection with one or more embodiments, it is to be understood that the specific mechanism and techniques, which have been described, are merely illustrative of the principles of the disclosure. Numerous modifications may be made to the methods and apparatus described herein without departing from the spirit and scope of the disclosure.

What is claimed is:

1. A protection system for a medical appliance on a limb of an animal comprising:
a tubular portion that is open at a first end and sealed at a second end, wherein said first end is adapted to receive the limb, wherein the limb extends substantially from said first end to said second end;
a first belt loop strap that is coupled to and that extends at least partially along a length of the tubular portion, wherein said first belt loop strap comprises at least one opening; and
at least one strap that fits through said opening and that secures said tubular portion to the limb.

2. The system of claim 1 further comprising at least one of a D-ring, an O-ring, Velcro, a hook, a barrel lock, and a buckle adapted to secure said at least one strap.

3. The system of claim 1 wherein said first end includes a contoured edge.

4. The system of claim 1 wherein said second end comprises a screened print for traction.

5. The system of claim 4 wherein said area comprises a screened print that provides said traction.

6. The system of claim 1 wherein said at least one strap comprises an elastic material.

7. The system of claim 1 wherein said first belt loop strap comprises a plurality of openings.

8. The system of claim 7 wherein said at least one strap laces through said plurality of openings.

9. The system of claim 7 further comprising a second belt loop strap comprising at least one opening.

10. The system of claim 9 wherein said at least one strap secures said tubular portion via said at least one opening of said second belt loop strap.

11. The system of claim 9 wherein another strap secures said tubular portion via said at least one opening of said second belt loop strap.

12. The system of claim 1 wherein said tubular portion comprises a semi-transparent poly-vinyl material.

13. A protection system for a medical appliance on a limb of an animal comprising:
a tubular portion that is open at a first end and closed at a second end, wherein said first end is adapted to receive the limb, wherein the limb extends from said first end to said second end;
a continuous belt loop strap that is coupled to and that extends at least partially along a length of the tubular portion, wherein said belt loop strap comprises a plurality of openings at various heights; and
a first strap that fits through one of said openings at a height based on a length of the limb and that secures said tubular portion to the limb.

14. The system of claim 13 further comprising at least one of a D-ring, an O-ring, Velcro, a hook, a barrel lock, and a buckle adapted to secure said first strap.

15. The system of claim 13 wherein said second end comprises an area for traction.

16. The system of claim 15 wherein said area comprises a screened print that provides said traction.

17. The system of claim 13 wherein said first strap comprises an elastic material.

18. The system of claim 13 wherein said at first strap laces through said plurality of openings.

19. The system of claim 13 further comprising a second strap, wherein said first strap secures said tubular portion at an upper portion of the limb through said one of said openings, and the second strap secures said tubular portion at a lower portion of the limb through a second one of said openings, wherein the upper and lower portions of the limb are separated by a joint.

20. A protection system for a medical appliance on a limb of an animal comprising:
a tubular portion that is open at a first end and closed at a second end, wherein said first end is adapted to receive the limb, wherein the limb extends from said first end to said second end;
a belt loop strap that is coupled to and that extends at least partially along a length of the tubular portion, wherein said belt loop strap comprises a plurality of openings at various heights; and
at least one strap that fits through at least a first and second of said openings to secure said tubular portion to the limb, wherein said first opening is above a joint of the limb and said second opening is below said joint of the limb.
